(19) United States
(12) Patent Application Publication
(10) Pub. No.: US 2026/0261193 A1
(43) Pub. Date: Sep. 3, 2026

(54) EMERGENCY PHASE-NUMBER CONTROL CIRCUIT FOR MULTIPHASE CONTROLLER, MULTIPHASE CONTROLLER, AND MULTIPHASE SWITCHING POWER SUPPLY LAMP CIRCUIT AND LIGHTING SYSTEM

(71) Applicant: Joulwatt Technology Co., Ltd., Hangzhou City (CN)

(72) Inventors: Pengpeng MA, Hangzhou (CN); Li SUN, Hangzhou (CN); Yang CHENG, Hangzhou (CN)

(21) Appl. No.: 19/538,688

(22) Filed: Feb. 12, 2026

(30) Foreign Application Priority Data
Feb. 28, 2025 (CN) 202510242033.5

(51) Int. Cl. H02M 1/00

(52) U.S. Cl. CPC H02M 1/0077

(57) ABSTRACT

A phase-number control circuit for a multiphase controller, a multiphase controller, and a multiphase switching power supply are provided. The multiphase controller comprises n PWM pins and n comparators corresponding to the n PWM pins. A k-th comparator receives a k-th load current sampling signal and a k-th threshold signal, and outputs a k-th comparison signal, wherein the k-th load current sampling signal is a load current sampling signal of an output rail of the k-th PWM pin, and the k-th threshold signal determines whether to turn on a switching circuit. The multiphase controller controls whether the switching circuit performs power operation according to the k-th comparison signal, and controls a multiphase switching power supply with an output rail count less than or equal to p, wherein 2 ≤ p ≤ n. Area and power consumption are reduced, and phase-switching response speed is increased.

### CROSS-REFERENCE TO RELATED APPLICATIONS

This present disclosure claims priority to a Chinese patent application No. 202510242033.5, filed on February, 28, 2025, and entitled "phase-number control circuit for multiphase controller, multiphase controller, and multiphase switching power supply", the entire contents of which are incorporated herein by reference, comprising the specification, claims, drawings and abstract.

### FIELD OF TECHNOLOGY

The present disclosure relates to the field of power electronics, and in particular, to a phase-number control circuit for a multiphase controller, a multiphase controller, and a multiphase switching power supply.

### BACKGROUND

Multiphase controllers in the prior art can support multiple output rails, are adapted to control multiphase switching power supplies having a plurality of output rails, and can flexibly configure the number of output rails and/or the number of PWM pins for each output rail. Assume a multiphase controller has n PWM pins, each PWM pin being used to output one phase of PWM signal, n being an integer greater than or equal to 2, the maximum number of supported output rails being p, p being an integer greater than or equal to 2 and less than or equal to n, and the maximum numbers of PWM pins that can be configured for the 1st to p-th output rails being M1 to Mp, respectively, M1 to Mp being positive integers less than or equal to n. Since there are n PWM pins, it can be used to control a multiphase switching power supply with a phase number (number of switching-circuit phases) less than or equal to n. When the multiphase controller is used to control a multiphase switching power supply with a phase number of m, m being an integer greater than or equal to 2 and less than or equal to n, the phase configuration information of the multiphase switching power supply (represented by "m1+m2+…+mp") needs to satisfy: m1+m2+…+mp=m, where m1 to mp are the phase numbers of the 1st to p-th output rails, respectively, m1≤M1, m2≤M2, …, mp≤Mp. For example, in one embodiment, n=12, p=4, M1=12, M2=6, M3=3, M4=3, m=12, then the phase configuration "m1+m2+…+mp" may be "12+0+0+0", or "6+6+0+0", or "3+3+3+3", or "6+3+2+1", etc. In order to improve efficiency, the multiphase controller needs to determine the optimal operating phase number (or the number of phases performing power operation) according to the load current of each output rail, and the phase-switching response speed is required to be relatively high.

Referring to FIGS. 1 and 2, FIG. 1 shows a prior-art multiphase controller 10 having n PWM pins, the maximum number of supported output rails being p, and the maximum numbers of PWM pins that can be configured for the 1st to p-th output rails being M1 to Mp, respectively. FIG. 2 shows a multiphase switching power supply 1 comprising a multiphase controller 10 with n=12, p=4, M1=12, M2=6, M3=3, M4=3, and 12-phase switching circuits 401-4012 (i.e., phase number is 12). The multiphase switching power supply 1 has four output rails and a phase configuration "m1+m2+m3+m4" of "6+3+2+1", the output voltages of the four output rails being Vo_{R1}-Vo_{R4}, the load currents being io_{R1}-io_{R4}, and Sio_{R1}-Sio_{R4} being the load current sampling signals of the four output rails. As shown in FIG. 1, the multiphase controller 10 comprises a phase-number control circuit 100 and a PWM signal generation module 300. The phase-number control circuit 100 comprises load current comparison modules 101-10pcorresponding one-to-one to the p output rails, and a logic circuit 110. The logic circuit 110 is used to output n enable signals EN1-ENn, and comprises sub-logic circuits 111-11p corresponding one-to-one to the p output rails. The PWM signal generation module 300 receives the n enable signals EN1-ENn, and controls the states of the n-phase PWM signals PWM1-PWMn according to the n enable signals EN1-ENn, so as to control whether the switching circuits corresponding to the PWM pins perform power operation. Specifically, the k-th output rail corresponds to the load current comparison module 10k and the sub-logic circuit 10k. The current comparison module 10k comprises one analog-to-digital converter ADCk and Mk comparators CMP. The analog-to-digital converter ADCk receives the load current sampling signal Sio_{Rk} of the k-th output rail. The first inputs of the Mk comparators CMP are all connected to the output of the analog-to-digital converter ADCk to receive the digital load current sampling signal of the k-th output rail, and the second inputs are respectively connected to different threshold signals th_{Rk-1}-th_{Rk-Mk} corresponding to the k-th output rail. The sub-logic circuit 10k outputs enable signals for controlling whether the switching circuits in the k-th output rail perform power operation according to the comparison signals L_{k_1}-L_{k_Mk} output by the Mk comparators CMP, wherein k is a positive integer less than or equal to n. In summary, the phase-number control circuit 100 of the prior-art multiphase controller 10 comprises p ADCs and M1+M2+…+Mp comparators. For example, in one embodiment shown in FIG. 2, the multiphase controller 10 has p=4, M1=12, M2=6, M3=3, M4=3, and the phase-number control circuit 100 needs 4 ADCs and 24 comparators. In another embodiment, if the multiphase controller 10 is set to p=4, M1=12, M2=12, M3=12, M4=12, the phase-number control circuit 100 needs 4 ADCs and 48 comparators. As is well known, high-speed ADCs themselves have large area and power consumption, and the phase-number control circuit 100 requires a very large number of comparators and multiple ADCs, which undoubtedly poses a great challenge to the area and power consumption of the multiphase controller 10. Moreover, due to the large data latency of ADCs, the phase-switching response speed of the multiphase controller 10 is also relatively low.

### SUMMARY OF THE DISCLOSURE

Accordingly, the present disclosure aims to provide a phase-number control circuit for a multiphase controller, a multiphase controller, and a multiphase switching power supply, to solve the technical problem in the prior art that the phase-number control circuit requires a very large number of comparators and multiple ADCs, resulting in large area, high power consumption, and slow phase-number switching response of the multiphase controller.

The technical solution of the present disclosure is to provide a phase number control circuit for a multiphase controller. The multiphase controller comprises n PWM pins, each PWM pin outputs one phase of PWM signal to control a corresponding switching circuit, wherein n is an integer greater than or equal to 2. The phase-number control circuit comprises:

n comparators, corresponding one-to-one to the n PWM pins, a k-th comparator corresponding to a k-th PWM pin receiving a k-th load current sampling signal at a first input and a k-th threshold signal at a second input, and outputting a k-th comparison signal at an output, wherein k is a positive integer less than or equal to n, the k-th load current sampling signal is a load current sampling signal of an output rail of the k-th PWM pin, and the k-th threshold signal is a threshold signal for determining whether to turn on a switching circuit corresponding to the k-th PWM pin,

wherein the multiphase controller controls whether the switching circuit corresponding to the k-th PWM pin performs power operation according to the k-th comparison signal, and the multiphase controller is configured to control a multiphase switching power supply with a phase number less than or equal to n and an output rail count less than or equal to p, wherein p is an integer greater than or equal to 2 and less than or equal to n.

Optionally, at least one of the n PWM pins is configurable to be assigned to different output rails.

Optionally, the phase-number control circuit receives the load current sampling signal of each output rail, and selects the load current sampling signal of one of the output rails as the k-th load current sampling signal according to configuration information of the k-th PWM pin.

Optionally, the configuration information of the k-th PWM pin comprises output-rail information configured for the k-th PWM pin,

the phase-number control circuit selects the load current sampling signal of one of the output rails as the k-th load current sampling signal according to the output-rail information configured for the k-th PWM pin,

Optionally, the phase-number control circuit further comprises:

at least one first selector, inputs of each first selector receiving load current sampling signals from at least two output rails, each first selector corresponding to one of the n comparators, the first selector corresponding to the k-th comparator selecting one of the load current sampling signals received at the inputs to output as the k-th load current sampling signal according to the output-rail information configured for the k-th PWM pin.

Optionally, the number of first selectors is greater than or equal to the number of PWM pins that is configurable to be assigned to different output rails, and each comparator corresponding to the PWM pin that is configurable to be assigned to different output rails is connected to one first selector.

Optionally, the configuration information of the k-th PWM pin further comprises phase sequence information configured for the k-th PWM pin,

the phase-number control circuit obtains the k-th threshold signal according to the phase sequence information configured for the k-th PWM pin, or according to the output-rail information configured for the k-th PWM pin and the phase sequence information configured for the k-th PWM pin,

wherein the phase sequence information configured for the k-th PWM pin is turn-on order information configured for the switching circuit corresponding to the k-th PWM pin within the output rail.

Optionally, the phase-number control circuit further comprises:

at least one second selector, inputs of each second selector receiving at least two threshold signals, each second selector corresponding to one of the n comparators, the second selector corresponding to the k-th comparator selecting one of the threshold signals received at the inputs to output as the k-th threshold signal according to the phase sequence information configured for the k-th PWM pin.

Optionally, the phase-number control circuit further comprises:

at least one two-stage selection circuit, each two-stage selection circuit comprising at least two first-stage selectors and one second-stage selector; inputs of each first-stage selector receiving at least two threshold signals, and inputs of each second-stage selector receiving output signals of the at least two first-stage selectors; each two-stage selection circuit corresponding to one of the n comparators; the first-stage selectors corresponding to the k-th comparator selecting one of the threshold signals received at the inputs as the output signals according to the phase sequence information configured for the k-th PWM pin; the second-stage selector corresponding to the k-th comparator selecting one of the output signals received at the inputs to output as the k-th threshold signal according to the output-rail information configured for the k-th PWM pin.

Optionally, the n comparators are analog comparators.

Optionally, the phase-number control circuit further comprises:

n digital-to-analog converters respectively corresponding one-to-one to the n comparators, wherein a k-th digital-to-analog converter corresponding to the k-th comparator converts the k-th threshold signal of digital type into the k-th threshold signal of analog type, and the second input of the k-th comparator receives the k-th threshold signal of analog type.

Optionally, the multiphase controller further comprises a storage unit,

the storage unit is configured to store the configuration information of the n PWM pins.

Optionally, the multiphase controller further comprises a built-in signal processing circuit.

wherein the built-in signal processing circuit receives current sampling signals of the switching circuits corresponding to the n PWM pins, and processes the current sampling signals to output the load current sampling signals of each output rail according to the output-rail information configured for each PWM pin.

In a second aspect, the present disclosure further provides a multiphase controller, comprising the phase-number control circuit mentioned above and a PWM signal generation module,

the PWM signal generation module is configured to output n-phase PWM signals to n PWM pins.

In a third aspect, the present disclosure further provides a multiphase switching power supply, comprising the multiphase controller mentioned above.

Compared with the prior art, the circuit structure of the present disclosure has the following advantages: the phase-number control circuit of the present disclosure requires a number of comparators equal to the number of PWM pins of the multiphase controller, the required number of comparators can be greatly reduced compared with the prior art, and no ADC is needed, so that the area and power consumption of the multiphase controller can be reduced and the phase-switching response speed can be increased.

### BRIEF DESCRIPTION OF THE DRAWINGS

FIG. 1 is a schematic circuit diagram of a multiphase controller in prior art.

FIG. 2 is a schematic circuit diagram of a multiphase switching power supply according to an embodiment of FIG. 1.

FIG. 3 is a schematic circuit diagram of a multiphase controller according to an embodiment of the present disclosure.

FIG. 4 is a schematic circuit diagram of a multiphase switching power supply according to an embodiment of FIG. 3.

FIG. 5 is a schematic circuit diagram of a multiphase switching power supply according to another embodiment of FIG. 3.

FIG. 6A is a schematic circuit diagram of the second selector corresponding to a k-th comparator in an embodiment of the present disclosure.

FIG. 6B is a schematic circuit diagram of a two-stage selection circuit corresponding to a k-th comparator in another embodiment of the present disclosure.

FIG. 7 is a schematic circuit diagram of a multiphase controller according to another embodiment of the present disclosure.

FIG. 8 is a schematic circuit diagram of a multiphase controller according to yet another embodiment of the present disclosure.

FIG. 9 is a schematic circuit diagram of a multiphase switching power supply according to an embodiment of FIG. 8.

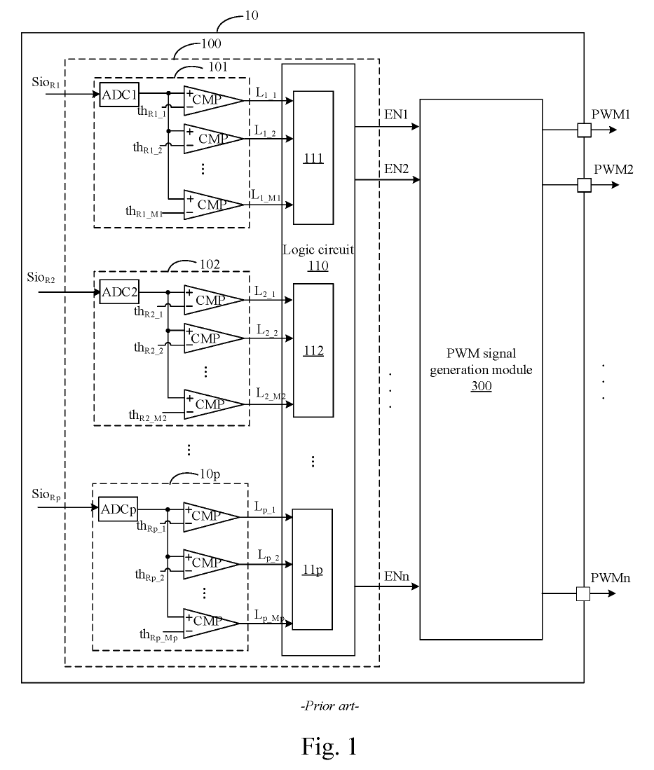

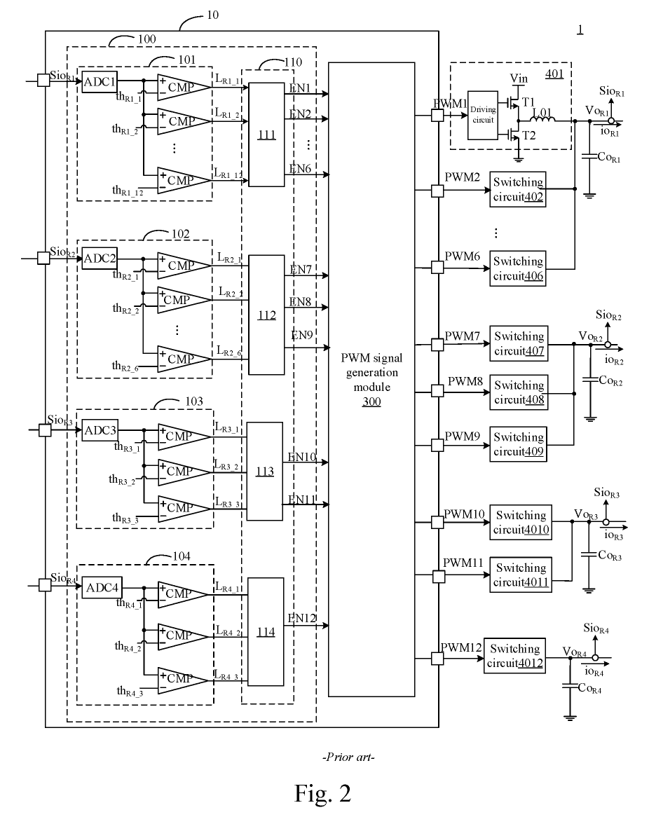

### DETAILED DESCRIPTION OF THE DISCLOSURE

The preferred embodiments of the present disclosure are described in detail below in conjunction with the accompanying drawings, but the present disclosure is not limited to these embodiments. The present disclosure covers any alternatives, modifications, equivalent methods and schemes made within the spirit and scope of the present disclosure.

In order to make the public fully understand the present disclosure, specific details are described in detail in the preferred embodiments of the present disclosure, but those skilled in the art can fully understand the present disclosure without the description of these details.

In the following paragraphs, the present disclosure is described more specifically by way of examples with reference to the accompanying drawings. It should be noted that the drawings are all in a simplified form and use non-precise proportions, only for the purpose of facilitating and clearly assisting the description of the embodiments of the present disclosure.

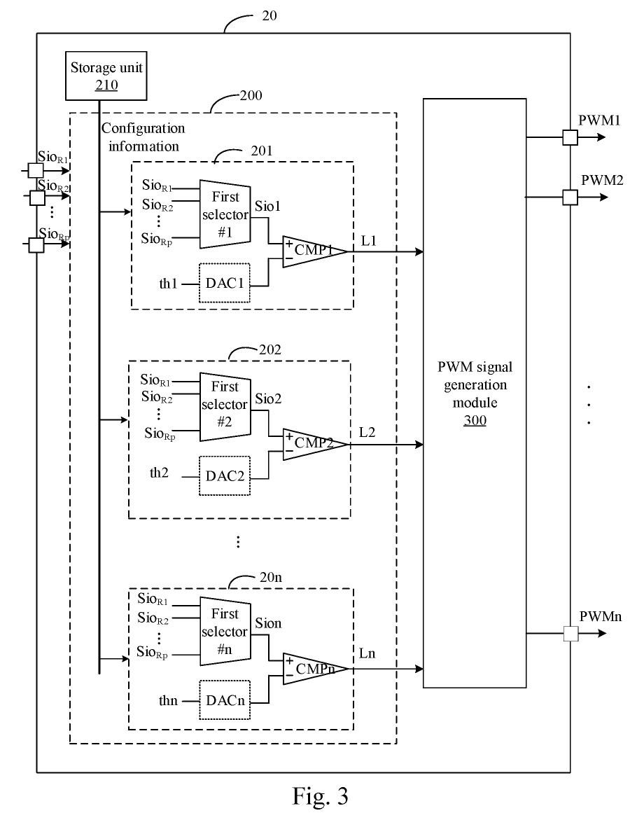

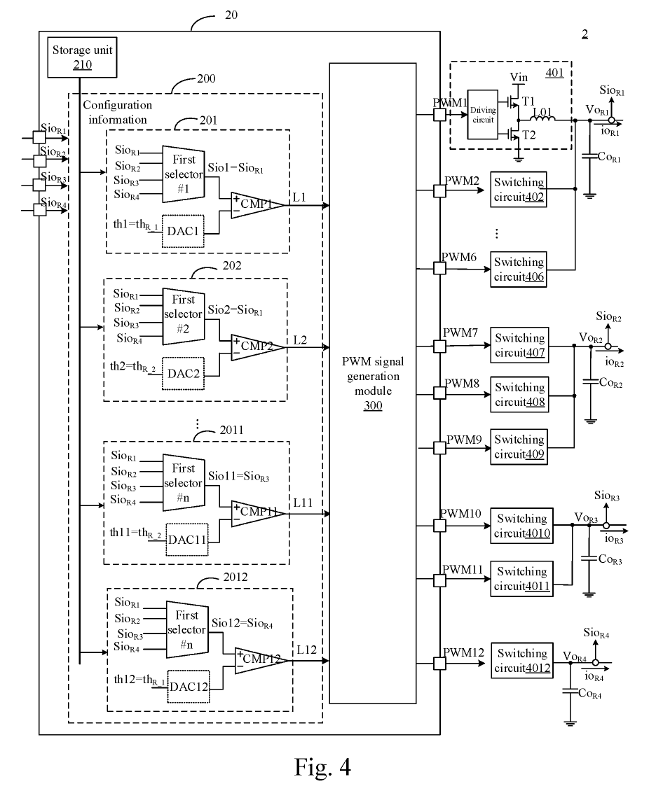

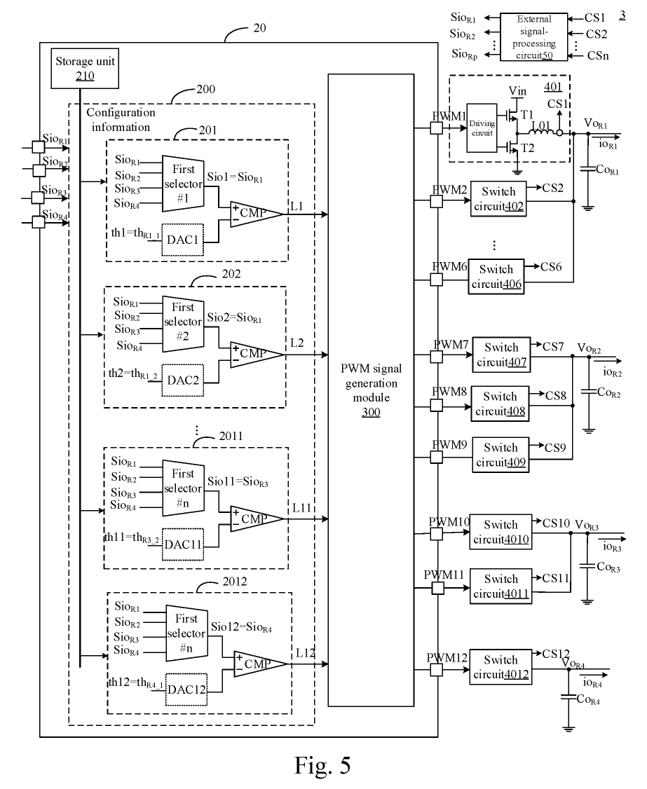

FIG. 3 shows a multiphase controller 20 according to an embodiment of the present disclosure, comprising n PWM pins, the maximum number of supported output rails being p, and the maximum numbers of PWM pins that can be configured for the 1st to p-th output rails being M1 to Mp, respectively, wherein n is an integer greater than or equal to 2, p is an integer greater than or equal to 2 and less than or equal to n, and M1 to Mp are positive integers less than or equal to n. FIGS. 4 and 5 show multiphase switching power supplies 2 and 3, respectively, each comprising a multiphase controller 20 with n=12 PWM pins and a maximum of p=4 output rails, and 12-phase switching circuits 401-4012, the number of output rails being 4 and the phase configuration "m1+m2+m3+m4" being "6+3+2+1", the output voltages of the four output rails being Vo_{R1}-Vo_{R4}, the load currents being io_{R1}-io_{R4}, and Sio_{R1}-Sio_{R4} being the load current sampling signals of the four output rails, respectively, representing the load currents of the four output rails. In the drawings of the present disclosure, PWM1-PWMn represent the PWM signals output by the 1st to n-th PWM pins, respectively.

Referring to FIGS. 3-5, in the multiphase controller 20 shown in FIG. 3, each of the n PWM pins is used to output one phase of PWM signal to control a corresponding switching circuit, wherein the multiphase controller 20 is adapted to control a multiphase switching power supply with a phase number less than or equal to n and an output rail count less than or equal to p, that is, the multiphase controller 20 supports a maximum of p output rails and a maximum of n phases. As shown in FIG. 3, the multiphase controller 20 comprises a phase-number control circuit 200, which comprises load current comparison modules 201-20n corresponding one-to-one to the n PWM pins, each load current comparison module comprising one comparator, i.e., the phase-number control circuit 200 comprises n comparators CMP1 to CMPn corresponding one-to-one to the n PWM pins. Specifically, a k-th comparator CMPk corresponding to a k-th PWM pin receives a k-th load current sampling signal Siok at a first input, a k-th threshold signal thk at a second input, and outputs a k-th comparison signal Lk at an output, wherein k is a positive integer less than or equal to n, the k-th load current sampling signal Siok is a load current sampling signal of an output rail of the k-th PWM pin, and the k-th threshold signal is a threshold signal for determining whether to turn on a switching circuit corresponding to the k-th PWM pin; the multiphase controller 20 controls whether the switching circuit corresponding to the k-th PWM pin performs power operation according to the k-th comparison signal Lk. It can be seen that the phase-number control circuit 200 of the multiphase controller 20 comprises n comparators CMP1-CMPn. For example, in the multiphase controller 20 with n=12 shown in FIGS. 4 and 5, the phase-number control circuit 200 only needs 12 comparators CMP1-CMP12, that is, the number of comparators in the phase-number control circuit 200 of the present embodiment is independent of the maximum numbers of PWM pins (M1-Mp) that can be configured for the 1st to p-th output rails. In contrast, the phase-number control circuit 100 of the prior art needs M1+M2+…+Mp comparators. Therefore, for a multiphase controller in which at least one of the n PWM pins is configurable to be assigned to different output rails, i.e., M1+M2+…+Mp>n, the scheme of the phase-number control circuit 200 of the present disclosure can reduce the required number of comparators compared with the prior art. Since the scheme of the phase-number control circuit 200 of the present disclosure can reduce the required number of comparators compared with the prior art, the n comparators CMP1-CMPn in the phase-number control circuit 200 can all be analog comparators, and the phase-number control circuit 200 does not need to use ADCs which have large area, high power consumption and large data latency. Therefore, the phase-number control circuit 200 of the present embodiment can reduce the area and power consumption of the multiphase controller 20 and increase the phase-switching response speed.

When all n comparators CMP1 to CMPn are configured as analog comparators, the first threshold signal th1 through the nth threshold signal thn received by each of the n comparators CMP1 to CMPn must be analog signals. For example, in one embodiment, if the first threshold signal th1 through the nth threshold signal thn shown in FIG. 3 are digital signals, each load current comparison module 201 to 20n in the phase-control circuit 200 requires a digital-to-analog converter (DAC); that is, the phase-control circuit 200 further comprises n DACs DAC1 to DACn respectively paired one-to-one with the n comparators CMP1 to CMPn. The k-th DAC, corresponding to the k-th comparator, converts the digital k-th threshold signal thk into an analog k-th threshold signal thk, and the second input of the k-th comparator receives this analog k-th threshold signal thk. In another embodiment, if the first threshold signal th1 through the nth threshold signal thn shown in FIG. 3 are already analog signals, no DACs are needed in the phase-control circuit 200. Since a DAC is superior to an ADC in terms of area and power consumption, the scheme of a phase-control circuit 200 comprising n DACs still reduces the area and power consumption of the multiphase controller 20 and improves phase-switching response speed compared with the prior art.

Further, in the embodiment shown in FIG. 3, the phase-control circuit 200 in the multiphase controller 20 receives the load-current sense signals Sio_{R1} to Sio_{Rp} of all output rails and, and selects the load current sampling signal of one of the output rails as the k-th load current sampling signal Siok based on the configuration information of the k-th PWM pin. Specifically, the configuration information of the k-th PWM pin comprises the output rail information configured for the k-th PWM pin. The phase control circuit 200 selects the load current sampling signal of one of the output rails based on the output rail information configured for the k-th PWM pin as the k-th load current sampling signal Siok. Wherein, regarding the specific situation of the k-th load current sampling signal Siok when the multiphase controller 20 is applied to a specific multiphase switching power supply, reference can be made to the embodiments shown in FIG. 4 or FIG. 5. The first PWM pin and the second PWM pin are configured to the first output rail, so the first load current sampling signal Sio1 and the second load current sampling signal Sio2 are both load current sampling signals Sio_{R1}of the first output rail. The 11th PWM pin is configured to the third output rail, so the 11th load current sampling signal Sio11 is the load current sampling signal Sio_{R3} of the third output rail; The 12th PWM pin is configured to the 4th output rail, so the 12th load current sampling signal Sio12 is the load current sampling signal Sio_{R4} of the 4th output rail. Based on the above introduction, it is easy to understand the situation of the third load current sampling signal Sio3 to the 10th load current sampling signal Sio10, which will not be repeated here.

Specifically, the phase-number control circuit 200 further comprises at least one first selector. Inputs of each first selector receives load current sampling signals from at least two output rails. Each first selector corresponds to one of the comparators CMP1 to CMPn among the n comparators. The first selector associated with the k-th comparator CMPk selects, according to the output-rail information configured for the k-th PWM pin, one of the signals received at an input and outputs it as the k-th load current sampling signal Siok. In the embodiment shown in FIG. 3, each load current comparison module 201 to 20n in the phase-number control circuit 200 comprises a first selector; that is, the phase-number control circuit 200 comprises n first selectors, and each first selector receives all output-rail load current sampling signals Sio_{R1} to Sio_{Rp} at inputs. It is readily understood that, in other embodiments, the number of first selectors and the number of signals received at the inputs of each first selector may be flexibly set according to the specific requirements of the multiphase controller. For example, the number of first selectors may be set greater than or equal to the number of PWM pins that can be assigned to different output rails, and each comparator corresponding to such a PWM pin is connected to a first selector. It may also be arranged that the input of the first selector corresponding to the k-th comparator receives at least the load current sampling signals of the output rails to which the k-th PWM pin can be assigned.

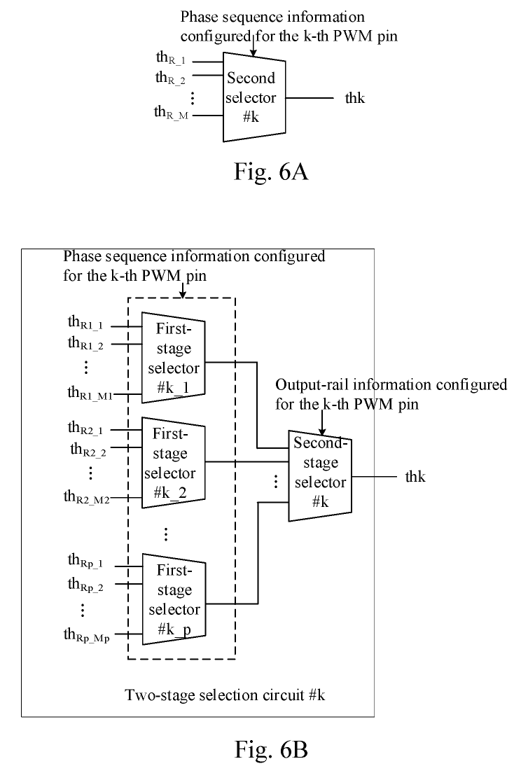

Furthermore, the configuration information of the k-th PWM pin also comprises the phase sequence information configured for the k-th PWM pin. The phase-number control circuit 200 obtains the k-th threshold signal thk according to the phase sequence information configured for the k-th PWM pin, or according to both the output-rail information and the phase sequence information configured for the k-th PWM pin. The phase sequence information configured for the k-th PWM pin is the turn-on order information of the switching circuit corresponding to the k-th PWM pin within the output rail. In some embodiments, the phase-number control circuit 200 further comprises at least one second selector (not shown in FIG. 3). Inputs of ach second selector receives at least two threshold signals, and each second selector corresponds to one of the n comparators CMP1 to CMPn. Referring to FIG. 6A, the second selector #k corresponding to the k-th comparator CMPk selects, according to the phase sequence information configured for the k-th PWM pin, one of the signals received at the input to output as the k-th threshold signal thk. As shown in FIG. 6A, the second selector #k receives M threshold signals th_{R_1}, th_{R_2}, …, th_{R_M}, where th_{R_1} to th_{R_M} represent the threshold signals when the PWM pin is assigned phase sequences 1 to M, i.e., when the switching circuit corresponding to the PWM pin is configured with turn-on orders 1 to M within the output rail. Correspondingly, when the multiphase controller 20 is applied in a specific multiphase switching power supply, the exact form of the k-th threshold signal thk can be understood with reference to the embodiment shown in FIG. 4: the first PWM pin and the twelfth PWM pin are both assigned phase sequence 1, so the first threshold signal th1 and the twelfth threshold signal th12 are both th_{R_1}; the second PWM pin and the eleventh PWM pin are both assigned phase sequence 2, so the second threshold signal th2 and the eleventh threshold signal th11 are both th_{R_2}. The cases of the third threshold signal th3 through the tenth threshold signal th10 can be readily inferred and are not repeated here. The number of second selectors in the phase-number control circuit 200 and the number M of signals received at inputs of each second selector can be flexibly set according to the specific requirements of the multiphase controller. For example, in one embodiment, the phase-number control circuit 200 may comprise n second selectors, and the number M of threshold signals received by each second selector may be set to the maximum among M1 to Mp. In another embodiment, the number of second selectors may be set according to the number of PWM pins that can be assigned different phase sequences, e.g., the number of second selectors may be greater than or equal to the number of PWM pins that can be assigned different phase sequences. Alternatively, the number of threshold signals received by the second selector #k may be determined according to the phase sequence information that can be assigned to the k-th PWM pin, e.g., the input of the second selector #k corresponding to the k-th comparator may be configured to receive at least the threshold signals corresponding to the phase sequences that can be assigned to the k-th PWM pin.

In some embodiments, the phase-number control circuit 200 may instead use a two-stage selection circuit to replace the aforementioned second selector. In these embodiments, the phase-number control circuit 200 comprises at least one two-stage selection circuit (not shown in FIG. 3). Each two-stage selection circuit comprises at least two first-stage selectors and one second-stage selector. The inputs of the first-stage selectors receive at least two threshold signals, and the inputs of the second-stage selector receive the output signals of the at least two first-stage selectors. Each two-stage selection circuit corresponds to one of the n comparators CMP1 to CMPn. Referring to FIG. 6B, in the two-stage selection circuit #k corresponding to the k-th comparator CMPk, at least one of the first-stage selectors #k_1 to #k_p selects, according to the phase sequence information configured for the k-th PWM pin, one signal from those received at its input as its output. The second-stage selector #k in two-stage selection circuit #k selects, according to the output-rail information configured for the k-th PWM pin, one signal from those signals received at its input to output as the k-th threshold signal thk. As shown in FIG. 6B, in one embodiment the input of first-stage selector #k_1 receives M1 threshold signals th_{R1_1}, th_{R1_2}, …, th_{R1_M1}, the input of first-stage selector #k_2 receives M2 threshold signals th_{R2_1}, th_{R2_2}, …, th_{R2_M2}, and so on, so that the input of first-stage selector #k_p receives Mp threshold signals th_{Rp_1,} th_{Rp_2}, …, th_{Rp_Mp}. Here, th_{R1_1} to th_{R1_M1} represent the threshold signals corresponding to PWM pins assigned to output rail 1 when their configured phase sequence is 1 to M1, i.e., the threshold signals corresponding to the turn-on order 1 to M1 within output rail 1 for the switching stages driven by those PWM pins. By extension, th_{Rp_1} to th_{Rp_Mp} represent the threshold signals corresponding to PWM pins assigned to output rail p when their configured phase sequence is 1 to Mp. Accordingly, for the specific case of the multiphase controller 20 applied in a multiphase switching power supply, the concrete form of the k-th threshold signal thk can be seen in the embodiment of FIG. 5: The first PWM pin and the second PWM pin are assigned to output rail 1 with phase sequences 1 and 2, so threshold signals th1 and th2 are th_{R1_1} and th_{R1_2}, respectively; the 11th PWM pin is assigned to output rail 3 with phase sequence 2, so threshold signal th11 is th_{R3_2}; the 12th PWM pin is assigned to output rail 4 with phase sequence 1, so threshold signal th12 is th_{R4_1}. The situations for threshold signals th3 to th10 are readily inferred and are not repeated here. It will be appreciated that the number of two-stage selection circuits in the phase-number control circuit 200, the number of first-stage selectors within each two-stage selection circuit, and the number of signals received at inputs of each first-stage selector can all be flexibly set according to the specific requirements of the multiphase controller.

Additionally, as shown in FIG. 3, the multiphase controller 20 further comprises a storage unit 210 and a PWM signal generation module 300. The storage unit 210 is used to store the configuration information of the n PWM pins. In one embodiment, the storage unit 210 can be configured externally, so that the configuration information of at least one PWM pin can be set from outside. For example, the storage unit 210 comprises registers. The PWM signal generation module 300 is configured to output n-phase PWM signals PWM1~PWMn to the n PWM pins, each PWM pin respectively outputting each PWM signal from the multiphase controller 20. In this embodiment, the PWM signal generation module 300 receives the comparison signals L1~Ln output by the n comparators, and controls the state of the PWM signal (PWMk signal) output to the k-th PWM pin according to the comparison signal Lk, so as to control whether the switching circuit corresponding to the k-th PWM pin operates. For example, when the PWMk signal is in a high-impedance state, the switching circuit corresponding to the k-th PWM pin is controlled not to operate; when the PWMk signal is in a non-high-impedance state (or an alternating high-low state), the switching circuit corresponding to the k-th PWM pin is controlled to operate.

In the multiphase switching power supply 2 shown in FIG. 4 and the multiphase switching power supply 3 shown in FIG. 5, the first-phase switching circuit 401 is exemplified with a buck topology, comprising a driver, a first transistor T1 and a second transistor T2 connected between input voltage Vin and ground, and an inductor L01 connected between the common node of the first transistor T1 and a second transistor T2 and the output of the first output rail; in other embodiments switching circuits 401 to 40n may adopt any other topology. The circuit structures of multiphase switching power supply 2 and multiphase switching power supply 3 are essentially identical; a key difference is that multiphase switching power supply 2 directly samples the load currents ioR1 to ioR4 of the respective output rails to obtain load-current sense signals Sio_{R1} to Sio_{R4}. The multiphase switching power supply 3 further comprises an external signal-processing circuit 50. The multiphase switching power supply 3 first acquires current sense signals CS1 to CSn from each switching circuit, and the external signal-processing circuit 50 then processes the current sense signals CS1 to CSn of the switching circuits according to the specific correspondence between each phase switching circuit and each output rail to generate the output-rail load-current sense signals Sio_{R1} to Sio_{Rp}.

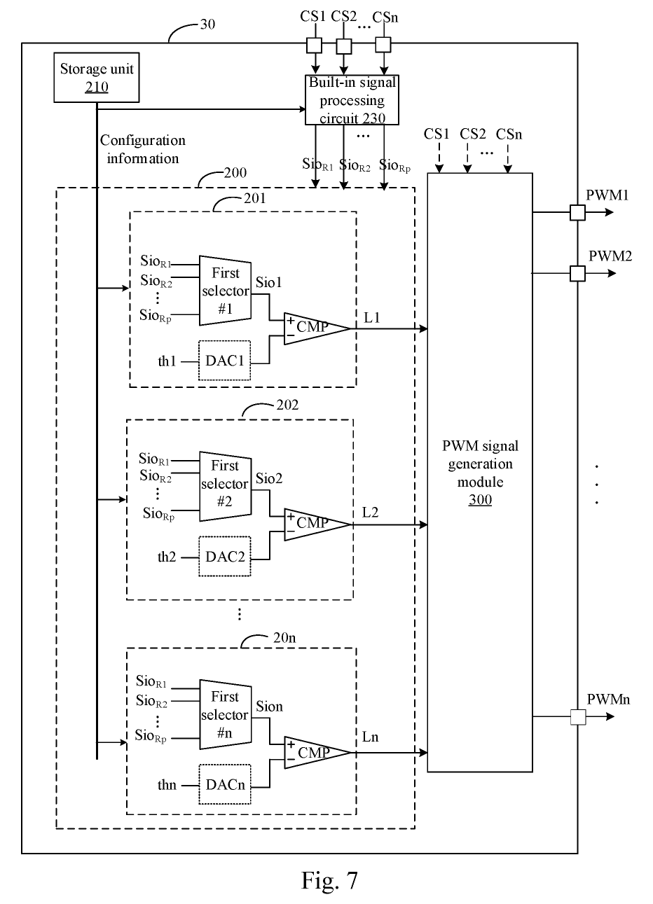

FIG. 7 is a schematic circuit diagram of a multiphase controller 30 according to another embodiment of the present disclosure. The multiphase controller 30 of this embodiment is substantially the same as the multiphase controller 20 shown in FIG. 3, and the description thereof is omitted here. The difference lies in that the multiphase controller 30 of this embodiment further comprises a built-in signal processing circuit 230. The built-in signal processing circuit 230 receives current sampling signals CS1 to CSn of the switching circuits corresponding to the n PWM pins, and processes the current sampling signals CS1 to CSn of the switching circuits according to the output-rail information configured for each PWM pin, so as to output load current sampling signals Sio_{R1} to Sio_{Rp} of the respective output rails. In embodiments where the multiphase controller itself must have pins for receiving the current sampling signals CS1 to CSn of the switching circuits. For example, when the PWM signal generation module 300 needs to generate the PWM signals PWM1 to PWMn based on the current sampling signals CS1 to CSn of the switching circuits, the multiphase controller is required to have pins for receiving the current sampling signals CS1 to CSn of the switching circuits. By adopting the multiphase controller 30 of this embodiment, compared with adopting the multiphase controller 20 shown in FIG. 3, p pins for respectively receiving the load current sampling signals Sio_{R1} to Sio_{Rp} of the output rails can be saved.

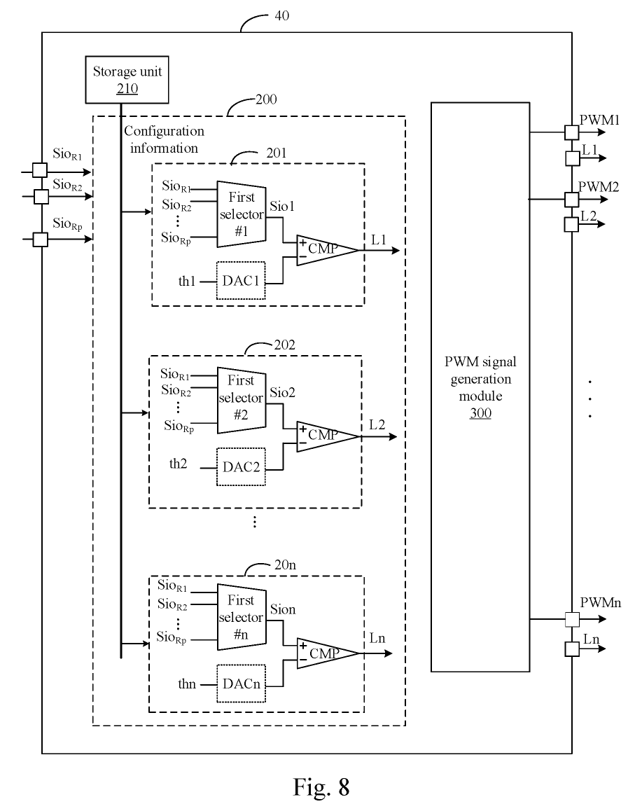

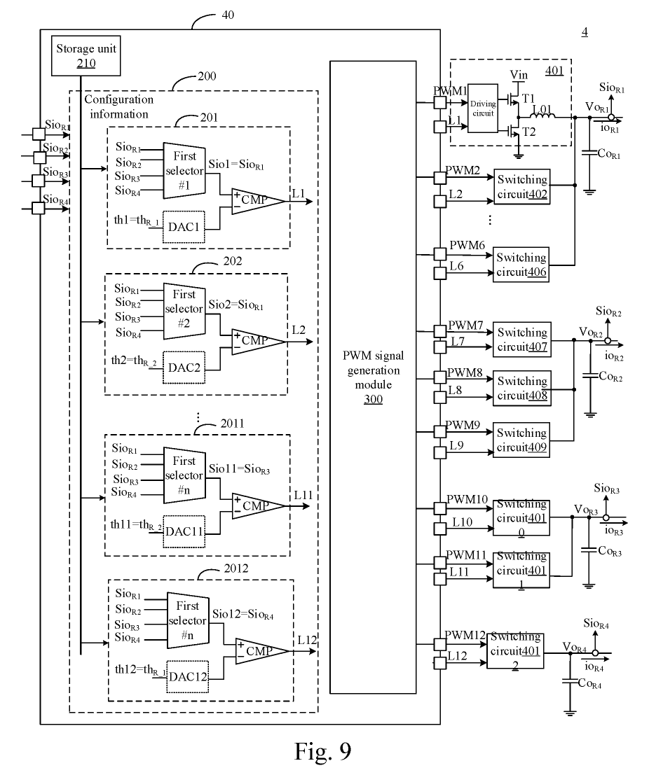

FIG. 8 is a schematic circuit diagram of a multiphase controller 40 according to yet another embodiment of the present disclosure, and FIG. 9 is a schematic circuit diagram of a multiphase switching power supply 4 according to an embodiment of FIG. 8. The circuit structure of the multiphase controller 40 shown in FIG. 8 is substantially the same as that of the multiphase controller 20 shown in FIG. 3 and will not be repeated here; the difference is that the PWM signal generation module 300 in the multiphase controller 40 of this embodiment does not receive the comparison signals L1 to Ln, and the multiphase controller 40 further comprises n pins for outputting the comparison signals L1 to Ln from the multiphase controller 40. Further referring to FIG. 9, the drive circuit of the switching circuit 40k corresponding to the k-th PWM pin receives the PWM signal PWMk output from the k-th PWM pin and the k-th comparison signal Lk, and the drive circuit of the switching circuit 40k controls whether the switching circuit 40k operates according to the logic level of the k-th comparison signal Lk.

It should be noted that the switching power supplies shown in FIGS. 4, 5, and 9 exemplify a multiphase controller with n = 12 PWM pins and a maximum supported output-rail count p = 4 applied to a multiphase switching power supply having 12 phases, 4 output rails, and a phase allocation "m1 + m2 + m3 + m4" of "6 + 3 + 2 + 1". It will be readily understood that, in other embodiments, the multiphase controller (with n = 12 PWM pins and p = 4 rails) can also be used in multiphase switching power supplies with fewer than 12 phases, fewer than 4 output rails, or different phase allocations.

In summary, the phase-number control circuit 200 of the present disclosure requires n comparators, where n is the number of PWM pins of the multiphase controller. The number of comparators is significantly reduced compared to the prior art, and the phase-number control circuit 200 of the present disclosure does not require an ADC, thereby reducing the area and power consumption of the multiphase controller and improving the phase-switching response speed.

The embodiments described above do not limit the scope of protection of this technical solution. Any modifications, equivalent substitutions, and improvements made within the spirit and principles of the above embodiments shall be comprised within the scope of protection of this technical solution.

What is claimed is:

1. A phase-number control circuit for a multiphase controller, the multiphase controller comprising n PWM pins, each PWM pin outputting one phase of PWM signal to control a corresponding switching circuit, wherein n is an integer greater than or equal to 2, wherein the phase-number control circuit comprises:
n comparators, corresponding one-to-one to the n PWM pins, a k-th comparator corresponding to a k-th PWM pin receiving a k-th load current sampling signal at a first input and a k-th threshold signal at a second input, and outputting a k-th comparison signal at an output, wherein k is a positive integer less than or equal to n, the k-th load current sampling signal is a load current sampling signal of an output rail of the k-th PWM pin, and the k-th threshold signal is a threshold signal for determining whether to turn on a switching circuit corresponding to the k-th PWM pin,
wherein the multiphase controller controls whether the switching circuit corresponding to the k-th PWM pin performs power operation according to the k-th comparison signal, and the multiphase controller is configured to control a multiphase switching power supply with a phase number less than or equal to n and an output rail count less than or equal to p, wherein p is an integer greater than or equal to 2 and less than or equal to n.

2. The phase-number control circuit according to claim 1, wherein at least one of the n PWM pins is configurable to be assigned to different output rails.

3. The phase-number control circuit according to claim 1, wherein the phase-number control circuit receives the load current sampling signal of each output rail, and selects the load current sampling signal of one of the output rails as the k-th load current sampling signal according to configuration information of the k-th PWM pin.

4. The phase-number control circuit according to claim 3, wherein the configuration information of the k-th PWM pin comprises output-rail information configured for the k-th PWM pin,
the phase-number control circuit selects the load current sampling signal of one of the output rails as the k-th load current sampling signal according to the output-rail information configured for the k-th PWM pin.

5. The phase-number control circuit according to claim 4, wherein the phase-number control circuit further comprises:
at least one first selector, inputs of each first selector receiving load current sampling signals from at least two output rails, each first selector corresponding to one of the n comparators, the first selector corresponding to the k-th comparator selecting one of the load current sampling signals received at the inputs to output as the k-th load current sampling signal according to the output-rail information configured for the k-th PWM pin.

6. The phase-number control circuit according to claim 5, wherein the number of first selectors is greater than or equal to the number of PWM pins that is configurable to be assigned to different output rails, and each comparator corresponding to the PWM pin that is configurable to be assigned to different output rails is connected to one first selector.

7. The phase-number control circuit according to claim 3, wherein the configuration information of the k-th PWM pin further comprises phase sequence information configured for the k-th PWM pin,
the phase-number control circuit obtains the k-th threshold signal according to the phase sequence information configured for the k-th PWM pin, or according to the output-rail information configured for the k-th PWM pin and the phase sequence information configured for the k-th PWM pin,
wherein the phase sequence information configured for the k-th PWM pin is turn-on order information configured for the switching circuit corresponding to the k-th PWM pin within the output rail.

8. The phase-number control circuit according to claim 7, wherein the phase-number control circuit further comprises:
at least one second selector, inputs of each second selector receiving at least two threshold signals, each second selector corresponding to one of the n comparators, the second selector corresponding to the k-th comparator selecting one of the threshold signals received at the inputs to output as the k-th threshold signal according to the phase sequence information configured for the k-th PWM pin.

9. The phase-number control circuit according to claim 7, wherein the phase-number control circuit further comprises:
at least one two-stage selection circuit, each two-stage selection circuit comprising at least two first-stage selectors and one second-stage selector; inputs of each first-stage selector receiving at least two threshold signals, and inputs of each second-stage selector receiving output signals of the at least two first-stage selectors; each two-stage selection circuit corresponding to one of the n comparators; the first-stage selectors corresponding to the k-th comparator selecting one of the threshold signals received at the inputs as the output signals according to the phase sequence information configured for the k-th PWM pin; the second-stage selector corresponding to the k-th comparator selecting one of the output signals received at the inputs to output as the k-th threshold signal according to the output-rail information configured for the k-th PWM pin.

10. The phase-number control circuit according to claim 1, wherein the n comparators are analog comparators.

11. The phase-number control circuit according to claim 10, wherein the phase-number control circuit further comprises:
n digital-to-analog converters respectively corresponding one-to-one to the n comparators, wherein a k-th digital-to-analog converter corresponding to the k-th comparator converts the k-th threshold signal of digital type into the k-th threshold signal of analog type, and the second input of the k-th comparator receives the k-th threshold signal of analog type.

12. The phase-number control circuit according to claim 3, wherein the multiphase controller further comprises a storage unit,
the storage unit is configured to store the configuration information of the n PWM pins.

13. The phase-number control circuit according to claim 4, wherein the multiphase controller further comprises a built-in signal processing circuit,
wherein the built-in signal processing circuit receives current sampling signals of the switching circuits corresponding to the n PWM pins, and processes the current sampling signals to output the load current sampling signals of each output rail according to the output-rail information configured for each PWM pin.

14. A multiphase controller, comprising the phase-number control circuit according to claim 1 and a PWM signal generation module,
the PWM signal generation module is configured to output n-phase PWM signals to n PWM pins.

15. A multiphase switching power supply, comprising the multiphase controller according to claim 14.
